(19) United States
(12) Patent Application Publication
(10) Pub. No.: US 2008/0142325 A1
(43) Pub. Date: Jun. 19, 2008

(54) Hydrodynamic torque converter

(75) Inventors: Mario Degler, Baden-Baden (DE); Stephan Maienschein, Baden-Baden (DE)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 11/998,049

(22) Filed: Nov. 28, 2007

(30) Foreign Application Priority Data
Nov. 29, 2006 (DE) 10 2006 056 299.2

(51) Int. Cl. F16H 45/02

(52) U.S. Cl. 192/3.29

(57) ABSTRACT

A hydrodynamic torque converter with a converter housing, comprising a converter cover, connectable or connected torque proof with a drive unit and with a guide ring, in which an end of a transmission input shaft is disposed rotatable on the radial inside, and at which a piston of a converter lockup clutch is supported on the radial outside, movable in an axial direction, and possibly rotatable, characterized in that the guide ring comprises a U-shaped ring cross section with a base, through which the guide ring is mounted to a component of the torque converter and from which a radially inner arm and a radially outer arm extend in the axial direction.

### CROSS REFERENCE TO RELATED APPLICATIONS

This patent claims priority of German Patent Application No. 10 2006 056 299.2, filed on Nov. 29, 2006, which application is incorporated herein by reference.

### FIELD OF THE INVENTION

The invention relates to a hydrodynamic torque converter with a converter housing, comprising a converter cover, which can be connected, or which is connected torque proof with a drive unit, and with a guide ring, in which an end of a transmission input shaft is disposed rotatable on the radial inside, and on which a piston of a converter lockup clutch is supported axially movable and possibly rotatable on the radial outside.

### BACKGROUND OF THE INVENTION

German publication document DE 103 50 935 A1 discloses a torque converter with a guide component, on which a press element is axially guided and sealed through seals.

### SUMMARY OF THE INVENTION

It is the object of the invention to provide a hydrodynamic torque converter which is simple in construction and inexpensive in manufacture.

The object is accomplished in a hydrodynamic torque converter with a converter housing, comprising a converter cover, which can be connected, or which is connected torque proof with a drive unit, and with a guide ring, in which an end of a transmission input shaft is rotatably supported on the radial inside, and on which a piston of a converter lockup clutch is supported axially movable and possibly rotatable on the radial outside, through the guide ring comprising a U-shaped ring cross section with a base, through which the guide ring is connected to a component of the torque converter, and from which a radial inner and a radial outer arm extend in axial direction. Through the guide ring according to the invention a multifunctional component is generated, which can be manufactured economically. Preferably, a guide ring is provided as a shaped sheet metal part.

A preferred embodiment of the hydrodynamic torque converter is characterized in that the radial inner arm of the U-shaped ring cross section contacts the transmission input shaft in a sealing manner. A major feature is the seal function of the radially inner arm. The radially inner arm of the U-shaped ring cross section can furthermore be used to guide the transmission input shaft and/or to center it.

Another preferred embodiment of the hydrodynamic torque converter is characterized in that the radially outer arm of the U-shaped ring cross section contacts the piston of the converter lockup clutch in a sealing manner. The seal function of the radially outer arm is a substantial feature. The radially outer arm of the U-shaped ring cross section can furthermore be used to guide and/or center the piston of the converter lockup clutch.

Another preferred embodiment of the hydrodynamic torque converter is characterized in that in the base of the U-shaped ring cross section, on the side facing away from the arms, flow channels are provided substantially extending in radial direction. Thereby, a targeted supply of hydraulic medium into a pressure chamber is facilitated in a simple manner.

Another preferred embodiment of the hydrodynamic torque converter is characterized in that flow channels are impressed into the base of the U-shaped ring cross section. The flow channels can also be formed by pass-through openings or indentations.

Another preferred embodiment of the hydrodynamic torque converter is characterized in that between the two arms of the U-shaped ring cross section a bearing device, in particular an axial bearing, for a damper hub is absorbed. The support device is centered by the guide ring, in particular by the radially inner arm of the U-shaped ring cross section.

Another preferred embodiment of the hydrodynamic torque converter is characterized in that the base of the U-shaped ring cross section has several pass-through holes, through which mounting elements extend, through which the guide ring is mounted to the component of the torque converter. The mounting elements are, e.g., bolt or rivet elements. Alternatively, the guide ring can also be connected with a component of the torque converter through material bonding, e.g., through welding or brazing.

Another preferred embodiment of the hydrodynamic torque converter is characterized in that the mounting elements, through which the guide ring is mounted to the component of the torque converter, can comprise rivet connection elements. Thereby, a stable mounting of the guide ring is facilitated in a simple manner.

Another preferred embodiment of the hydrodynamic torque converter is characterized in that the mounting elements, through which the guide ring is mounted to the component of the torque converter, comprise rivet buds, extending from the component at which the guide ring is mounted. Thereby, the manufacturing costs can be reduced.

Another preferred embodiment of the hydrodynamic torque converter is characterized in that the guide ring is mounted to a secondary component of a rotation vibration damper, or to the converter cover, with the base of the U-shaped ring cross section. The rotation vibration absorber is connected between the converter cover and the converter lockup clutch, in particular an outer disk carrier of the converter lockup clutch.

Another preferred embodiment of the hydrodynamic torque converter is characterized in that the guide ring is formed from sheet metal. Thereby, the manufacturing costs can be reduced.

The invention furthermore relates to a torque transfer device, in particular in the drive train of a motor vehicle with a transmission input shaft and a previously described hydrodynamic torque converter for transferring torque between the drive unit and a transmission. Preferably, at least one rotation vibration damper is integrated into the torque transfer device.

### BRIEF DESCRIPTION OF THE DRAWINGS

Additional advantages, features, and details of the invention can be derived from the following detailed description, in which various embodiments are described with reference to the drawings, in which:

FIG. 1 illustrates a torque transfer device according to a first embodiment in a semi-sectional view; and,

FIG. 2 is an enlarged cutout from FIG. 1 according to another embodiment.

### DETAILED DESCRIPTION OF THE INVENTION

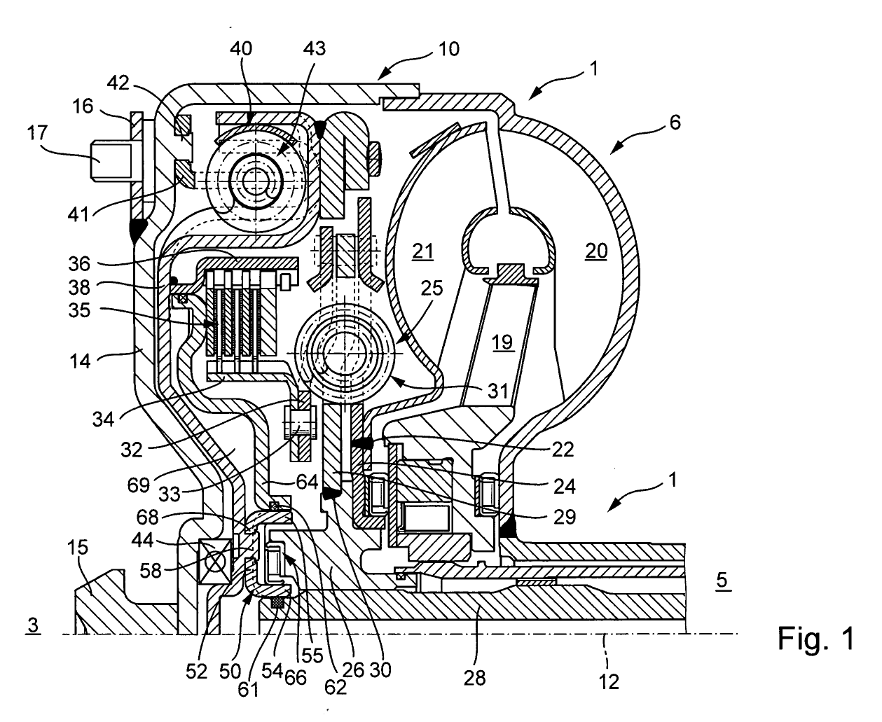

In FIG. 1a portion of drive train 1 of a motor vehicle is illustrated. Between drive unit 3, in particular a combustion engine, which is only indicated by a reference numeral, and from which a crank shaft extends, and transmission 5, which is also only indicated through a reference numeral, hydrodynamic torque converter 6 is disposed. The crank shaft of combustion engine 3 is, e.g., connected non-rotatably with housing 10 of torque converter 6, e.g., through a drive plate, which is also designated as flex plate. Housing 10 of torque converter 6 is rotatable around a rotation axis and provided with housing wall 14 close to the drive, which is also designated as a converter cover.

Central pilot bearing pinion 15 is mounted to the converter cover, which is used for centering hydrodynamic torque converter 6 during assembly in a center cutout of the crank shaft. On the radial outside, connection plate 16 is welded to converter cover 14, from which threaded studs 17 extend, through which converter cover 14 is mounted to the drive plate.

Hydrodynamic torque converter 6 comprises stator shell 19, pump shell 20, and turbine shell 21. Turbine shell 21 is connected through weld 22 with side plate 24 in a solid manner. Side plate 24 forms the input component of rotation vibration absorber 25, which is disposed in the axial direction between converter cover 14 and turbine shell 21. Rotation vibration damper 25 comprises damper hub 26, on which side plate 24 and turbine shell 21 mounted thereon, are connected on the radial outside in a rotatable manner.

Damper hub 26 is connected non-rotatably on the radial inside with transmission input shaft 28. The output component of rotation vibration damper 25 is formed by damper flange 29, which is connected with damper hub 26 through weld 30 in a solid manner. Damper flange 29 is coupled with side plate 24 and another side plate 32 through spring elements 31, disposed in between. Side plate 32, which forms another input component of the rotation vibration damper 25, is connected through rivet connection elements 33 with an inner disk carrier 34 of a converter lockup clutch 35 in multi disk construction in a solid manner.

Converter lockup clutch 35 furthermore comprises outer disk carrier 36, mounted to output component 38 of another rotation vibration absorber 40. Rotation vibration absorber 40 comprises input component 41, which is mounted to converter cover 14 through rivet connection elements 42. Rivet connection elements 42 are formed by rivet buds extending from converter cover 14. Input component 41 of rotation vibration absorber 40 is coupled with output component 38. Between output component 38 of rotation vibration absorber 40 and converter cover 14, roller bearing 44, in particular a ball bearing is disposed. Output component 38 of rotation vibration absorber 40 is supported rotatably at converter cover 14 through roller bearing 44.

Guide ring 50 is disposed at output component 38 of rotation vibration absorber 40. Guide ring 50 is a sheet metal part with a U-shaped cross section. The U-shaped cross section of guide ring 50 comprises base 52, from which two arms 54, 55 extend in the axial direction towards transmission 5. Arm 54 is disposed on the radial inside and is thus also designated as inner radial arm 54. Analogously, arm 55 is designated as outer radial arm 55. The two arms 54 and 55 have approximately equal length.

Base 52 of guide ring 50 has several pass-through holes distributed over its circumference. Rivet buds 58, which are pressed out from output component 38, which is provided as a sheet metal part; extend through the pass-through components, as can be seen in FIG. 1. Through rivet buds 58, of which only one is visible in cross section in FIG. 1, guide ring 50 is mounted with its base 52 to output component 38 of rotation vibration absorber 40.

Radially inner arm 54 of guide ring 50 forms a seal ring, in which an end with a shoulder of transmission input shaft 28 is disposed rotatable with a sealing effect. In order to improve the seal effect, radially inner arm 54 contacts seal ring 61, which is partially received in a ring groove, which is formed in the end with a shoulder of transmission input shaft 28 and which has a rectangular cross section. Another seal ring 62 is partially received in a ring groove, which is provided at piston 64 of converter lockup clutch 35. Piston 64 is supported on radially outer arm 55 of guide ring 50 in a sealing manner, and axially movable and possibly rotatable.

In the radial direction, between two arms 54, 55 of guide ring 50, an annular chamber is formed, which is used for housing bearing device 66 according to another aspect of the invention. Bearing device 66 is preferably an axial bearing, which is used for supporting axial forces. Alternatively or additionally, it can also be a radial bearing. Bearing 66 is, e.g., provided as straight bearing or roller bearing. Guide ring 50 is used for receiving and centering bearing 66.

Base 52 of guide ring 50 has flow channels on its side facing drive unit 3 as indicated by broken line 68. The flow channels allow a directed supply of hydraulic oil into pressure chamber 69. The flow channels are preferably impressed into base 52 of guide ring 50.

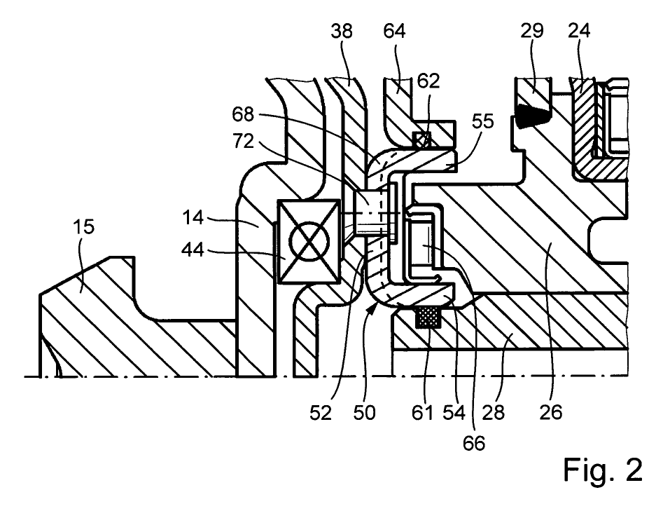

In FIG. 2, the cutout with guide ring 50 of FIG. 1 is illustrated according to another embodiment in an enlarged manner. For designating identical parts, the same reference numerals as in FIG. 1 are used. Different from the embodiment shown in FIG. 1, guide ring 50 is not mounted to output component 38 through rivet buds, but through rivet connection elements 72. In FIG. 2, only one rivet connection element 72 is visible, which extends through pass-through holes, which are cut out in base component 38 and in base 52 of guide ring 50, so they are in alignment.

### DESIGNATIONS

1 drive train
3 drive unit
5 transmission
6 hydrodynamic torque converter
10 housing
12 rotation axis
14 housing wall
15 pilot bearing pinion
16 connection plate
17 threaded bolt
19 stator shell
20 pump shell
21 turbine shell
22 welded connection
24 side plate
25 rotation vibration absorber
26 damper hub
28 transmission input shaft
29 damper flange
30 weld
31 spring element
32 side plate
33 rivet connection element
34 inner disk carrier
35 converter lockup clutch
36 outer disk carrier
38 output component
40 rotation vibration damper
41 input component
42 rivet connection elements
43 spring elements
44 roller bearing
50 guide ring
52 base
54 arm
55 arm
58 rivet buds
61 seal ring
62 seal ring
64 piston
66 bearing device
68 broken line
69 pressure chamber
72 rivet connection elements

What is claimed is:

1. A hydrodynamic torque converter with a converter housing (10), comprising a converter cover (14), connectable or connected non-rotatably with a drive unit (3) and with a guide ring (50), in which an end of a transmission input shaft (28) is disposed rotatable on the radial inside, and at which a piston (64) of a converter lockup clutch (35) is supported on the radial outside, movable in an axial direction, and possibly rotatably, wherein the guide ring (50) comprises a U-shaped ring cross section with a base (52), through which the guide ring (50) is mounted to a component of the torque converter and from which a radially inner arm (54) and a radially outer arm (55) extend in the axial direction.

2. The hydrodynamic torque converter recited in claim 1, wherein the radially inner arm (54) of the U-shaped ring cross section contacts the transmission input shaft (28) in a sealing manner.

3. The hydrodynamic torque converter recited in claim 1, wherein the radially outer arm (55) of the U-shaped ring cross section contacts the piston (64) of the converter lockup clutch (35) in a sealing manner.

4. The hydrodynamic torque converter recited in claim 1, wherein flow channels (68) are provided in the base (52) of the U-shaped ring cross section on the side facing away from the arms (54, 55), wherein said flow channels extend substantially in a radial direction.

5. The hydrodynamic torque converter recited in claim 4, wherein the flow channels (68) are impressed into the base (52) of the U-shaped ring cross section.

6. The hydrodynamic torque converter recited in claim 1, wherein a bearing device (66), in particular an axial bearing for a damper hub (26), is disposed between the two arms (54, 55) of the U-shaped ring cross section.

7. The hydrodynamic torque converter recited in claim 1, wherein the base (52) of the U-shaped ring cross section has several pass-through openings, through which the mounting elements (58, 72) extend, through which the guide ring (50) is mounted to the component of the torque converter.

8. The hydrodynamic torque converter recited in claim 8, wherein the mounting elements (72), through which the guide ring (50) is mounted to the component of the torque converter comprise rivet connection elements.

9. The hydrodynamic torque converter recited in claim 8, wherein the mounting elements (58), through which the guide ring (50) is mounted to the component of the torque converter, comprise rivet buds, extending from the component to which the guide ring (50) is mounted.

10. The hydrodynamic torque converter recited in claim 9, wherein the guide ring (50) is mounted to a secondary component (38) of a rotation vibration absorber (40), or to the converter cover through the base (52) of the U-shaped ring cross section.

11. The hydrodynamic torque converter recited in claim 10, wherein the guide ring (50) is made from sheet metal.

12. A torque converter device, in particular in the drive train (1) of a motor vehicle with a transmission input shaft (28) and with a hydrodynamic torque converter (6) with a converter housing (10), comprising a converter cover (14), connectable or connected non-rotatably with a drive unit (3) and with a guide ring (50), in which an end of a transmission input shaft (28) is disposed rotatable on the radial inside, and at which a piston (64) of a converter lockup clutch (35) is supported on the radial outside, movable in an axial direction, and possibly rotatably, wherein the guide ring (50) comprises a U-shaped ring cross section with a base (52), through which the guide ring (50) is mounted to a component of the torque converter and from which a radially inner arm (54) and a radially outer arm (55) extend in the axial direction, for transferring torque between the drive unit (3) and the transmission (5).
